(19) United States
(12) Patent Application Publication
(10) Pub. No.: US 2024/0426514 A1
(43) Pub. Date: Dec. 26, 2024

(54) VENTILATION-TYPE SILENCER

(71) Applicant: FUJIFILM Corporation, Tokyo (JP)

(72) Inventors: Shinya Hakuta, Ashigarakami-gun (JP); Shogo YAMAZOE, Ashigarakami-gun (JP); Yuichiro ITAI, Ashigarakami-gun (JP); Yoshihiro SUGAWARA, Ashigarakami-gun (JP)

(73) Assignee: FUJIFILM Corporation, Tokyo (JP)

(21) Appl. No.: 18/829,482

(22) Filed: Sep. 10, 2024

Related U.S. Application Data
(63) Continuation of application No. PCT/JP2023/005114, filed on Feb. 15, 2023.

(30) Foreign Application Priority Data
Mar. 28, 2022 (JP) 2022-051373

(51) Int. Cl. F24F 13/24

(52) U.S. Cl. CPC F24F 13/24; F24F 2013/242; F24F 2013/245

(57) ABSTRACT

There is provided a ventilation-type silencer that uses a porous sound absorbing material and has high sound deadening performance in a low frequency band. A ventilation-type silencer includes an inlet-side vent pipe, an expansion section that communicates with the inlet-side vent pipe and has a cross-sectional area larger than a cross-sectional area of the inlet-side vent pipe, and an outlet-side vent pipe that communicates with the expansion section and has a cross-sectional area smaller than the cross-sectional area of the expansion section. The ventilation-type silencer includes a porous sound absorbing material that is disposed in at least a part of the expansion section, a back space that is a space in the expansion section formed on a side of the porous sound absorbing material opposite to a flow channel connecting the inlet-side vent pipe and the outlet-side vent pipe, and a partition member that partitions the back space. A region partitioned by the partition member forms an acoustic resonator, and the acoustic resonator is acoustically connected to the flow channel.

### CROSS-REFERENCE TO RELATED APPLICATIONS

This application is a Continuation of PCT International Application No. PCT/JP2023/005114 filed on Feb. 15, 2023, which claims priority under 35 U.S.C. § 119 (a) to Japanese Patent Application No. 2022-051373 filed on Mar. 28, 2022. The above applications are hereby expressly incorporated by reference, in their entirety, into the present application.

### BACKGROUND OF THE INVENTION

### 1. Field of the Invention

The present invention relates to a ventilation-type silencer.

### 2. Description of the Related Art

A ventilation-type silencer that is installed in the middle of a vent pipe and that includes an expansion section having a cross-sectional area larger than that of the vent pipe is known as a silencer that deadens noise from a gas supply source or the like in the middle of a vent pipe that transports gas. Further, in order to further improve sound deadening performance, porous sound absorbing materials are also disposed in the expansion section. In the ventilation-type silencer, the porous sound absorbing materials are disposed along a flow channel such that a space serving as a ventilation channel is provided in a central portion.

The sound absorbing performance of the porous sound absorbing material depends on the volume of the porous sound absorbing material. Therefore, in order to improve sound absorbing performance, it is necessary to arrange a lot of the porous sound absorbing materials. However, in a case where the number of porous sound absorbing materials is increased, problems, such as the occurrence of mold, are likely to occur since water infiltrates into the porous sound absorbing materials and the porous sound absorbing materials are unlikely to be dried in a case of being wet with water or the like, problems that the porous sound absorbing materials are likely to be burned, cost is increased due to the cost of the materials and man-hours for filling, or dust is finally increased, and the like occur.

For this reason, it is considered to improve sound absorbing performance by using a small amount of porous sound absorbing material.

For example, JP2019-132576A discloses a crank box type-sound deadening ventilation structure in which a decorative plate separating two spaces and a wall are provided to communicate with each other. The sound deadening ventilation structure includes: a hollow sound deadening container that is disposed in a space between the decorative plate and the wall; at least two opening pipe parts that are connected to two side surfaces, which face each other, of the sound deadening container, respectively, and communicate with a space in the sound deadening container; a sound absorbing material that is provided in the sound deadening container; and a coating material that coats a part of a surface of the sound absorbing material. The opening pipe part of one side surface of the sound deadening container is disposed to communicate with the decorative plate, the opening pipe part of the other side surface of the sound deadening container is disposed to communicate with the wall, the opening pipe part of one side surface and the opening pipe part of the other side surface are disposed at positions different from each other in a longitudinal direction of the sound deadening container, and the coating material causes another part of the surface of the sound absorbing material to be exposed such that an exposed portion is formed as at least one contact surface in contact with the space in the sound deadening container.

### SUMMARY OF THE INVENTION

JP2019-132576A discloses that a sound absorbing effect of the porous sound absorbing material can be increased since sound pressure on the contact surface in contact with the ventilation channel can be increased and a particle speed can be increased in a case where a part of the porous sound absorbing material is coated.

Further, a configuration in which a space (hereinafter, referred to as a back space) is provided on a side of the porous sound absorbing material opposite to a ventilation channel side (hereinafter, referred to as a back side) is conceived as a configuration that increases a sound absorbing effect with a small amount of porous sound absorbing material. In a case where the back side of the porous sound absorbing material is in direct contact with the wall, sound waves entering the porous sound absorbing material from the ventilation channel are reflected by the wall and return to the ventilation channel. For this reason, a sound absorbing effect of the porous sound absorbing material is not likely to be sufficiently obtained. On the other hand, since the back space is provided on the back side of the porous sound absorbing material, it is possible to inhibit the sound waves, which enter the porous sound absorbing material from the ventilation channel, from being reflected and returning to the ventilation channel. For this reason, a sound absorbing effect of the porous sound absorbing material can be further improved.

However, according to the studies performed by the present inventors, it was found that there is a problem that sound deadening performance in a low frequency band is low in the case of the configuration in which the back space is provided on the back side of the porous sound absorbing material.

An object of the present invention is to solve the problems in the related art and to provide a ventilation-type silencer that uses a porous sound absorbing material and has high sound deadening performance in a low frequency band.

In order to achieve the object, the present invention has the following configuration.

[1] A ventilation-type silencer including an inlet-side vent pipe, an expansion section that communicates with the inlet-side vent pipe and has a cross-sectional area larger than a cross-sectional area of the inlet-side vent pipe, and an outlet-side vent pipe that communicates with the expansion section and has a cross-sectional area smaller than the cross-sectional area of the expansion section, the ventilation-type silencer comprising:
a porous sound absorbing material that is disposed in at least a part of the expansion section;
a back space that is a space in the expansion section formed on a side of the porous sound absorbing material opposite to a flow channel connecting the inlet-side vent pipe and the outlet-side vent pipe; and
a partition member that partitions the back space,
in which a region partitioned by the partition member forms an acoustic resonator, and
the acoustic resonator is acoustically connected to the flow channel.

[2] The ventilation-type silencer according to [1],
in which resonance of the acoustic resonator is air column resonance.

[3] The ventilation-type silencer according to [1],
in which the partition member includes a part that protrudes toward the acoustic resonator at an end portion thereof facing the porous sound absorbing material, and
resonance of the acoustic resonator is Helmholtz resonance.

[4] The ventilation-type silencer according to any one of [1] to [3],
in which the partition member does not adhere to at least one of two walls, which surround the acoustic resonator and face each other, among walls of the expansion section.

[5] The ventilation-type silencer according to [4],
in which a distance between the partition member and the wall not adhering to the partition member is 5 mm or less.

[6] The ventilation-type silencer according to any one of [1] to [5],
in which the partition member is in contact with the porous sound absorbing material. [7] The ventilation-type silencer according to any one of [1] to [6],
in which at least one surface of the expansion section is a flat surface. [8] The ventilation-type silencer according to [7],
in which a lowest natural frequency of the flat surface after the ventilation-type silencer is formed to include the partition member is 2000 Hz or less.

[9] The ventilation-type silencer according to any one of claims [1] to [8],
in which the partition member is formed integrally with the expansion section.

[10] The ventilation-type silencer according to [9],
in which a thickness of the partition member is constant or monotonically reduced in at least one direction of directions away from a wall of the expansion section from a position at which the partition member is joined to the wall of the expansion section.

[11] The ventilation-type silencer according to any one of [1] to [10],
in which all sides of the partition member are straight.

[12] The ventilation-type silencer according to any one of [1] to [11], further comprising:
an opening structure that is provided on at least one of a connection portion of the expansion section connected to the inlet-side vent pipe or a connection portion of the expansion section connected to the outlet-side vent pipe and has a cross-sectional area gradually increased from the connection portion toward an inside of the expansion section.

According to the present invention, it is possible to provide a ventilation-type silencer that uses a porous sound absorbing material and has high sound deadening performance in a low frequency band.

### BRIEF DESCRIPTION OF THE DRAWINGS

FIG. 1 is a cross-sectional view conceptually showing an example of a ventilation-type silencer according to an embodiment of the present invention.

FIG. 2 is a cross-sectional view taken along line B-B of FIG. 1.

FIG. 3 is a cross-sectional view conceptually showing another example of the ventilation-type silencer according to the embodiment of the present invention.

FIG. 4 is a perspective view of an opening structure of the ventilation-type silencer shown in FIG. 1.

FIG. 5 is a perspective view conceptually showing another example of the opening structure.

FIG. 6 is a perspective view conceptually showing another example of the opening structure.

FIG. 7 is a cross-sectional view conceptually showing another example of the ventilation-type silencer according to the embodiment of the present invention.

FIG. 8 is a cross-sectional view conceptually showing another example of the ventilation-type silencer according to the embodiment of the present invention.

FIG. 9 is a cross-sectional view conceptually showing another example of the ventilation-type silencer according to the embodiment of the present invention.

FIG. 10 is a cross-sectional view conceptually showing another example of the ventilation-type silencer according to the embodiment of the present invention.

FIG. 11 is a cross-sectional view conceptually showing a ventilation-type silencer of Comparative Example.

FIG. 12 is a cross-sectional view taken along line C-C of FIG. 11.

FIG. 13 is a graph showing a relationship between a frequency and a transmission loss.

FIG. 14 is a graph showing a relationship between a frequency and a transmission loss.

FIG. 15 is a graph showing a relationship between a frequency and a transmission loss.

FIG. 16 is a cross-sectional view conceptually showing the ventilation-type silencer of Comparative Example.

FIG. 17 is a graph showing a relationship between a frequency and a transmission loss.

FIG. 18 is a graph showing a relationship between a frequency and a transmission loss.

### DESCRIPTION OF THE PREFERRED EMBODIMENTS

A ventilation-type silencer according to an embodiment of the present invention will be described in detail below.

The descriptions of configuration requirements to be made below will be based on a representative embodiment of the present invention, but the present invention is not limited to such an embodiment.

Further, in this specification, a numerical range described using “to” means a range that includes numerical values written in the front and rear of “to” as a lower limit and an upper limit.

Furthermore, in this specification, “perpendicular” and “parallel” include the range of an error to be allowed in a technical field to which the present invention pertains. For example, “perpendicular” and “parallel” mean that an angle is in a range including an error smaller than ±10° from exact perpendicular or exact parallel, and an error from exact perpendicular or exact parallel is preferably 5° or less and more preferably 3º or less.

In this specification, terms, such as “same” and “identical”, include the range of an error to be generally allowed in a technical field.

### [Ventilation-Type Silencer]

The ventilation-type silencer according to the embodiment of the present invention is a ventilation-type silencer including an inlet-side vent pipe, an expansion section that communicates with the inlet-side vent pipe and has a cross-sectional area larger than a cross-sectional area of the inlet-side vent pipe, and an outlet-side vent pipe that communicates with the expansion section and has a cross-sectional area smaller than the cross-sectional area of the expansion section. The ventilation-type silencer includes: a porous sound absorbing material that is disposed in at least a part of the expansion section; a back space that is a space in the expansion section formed on a side of the porous sound absorbing material opposite to a flow channel connecting the inlet-side vent pipe and the outlet-side vent pipe; and a partition member that partitions the back space. A region partitioned by the partition member forms an acoustic resonator, and the acoustic resonator is acoustically connected to the flow channel.

A configuration of the ventilation-type silencer according to the embodiment of the present invention will be described with reference to the drawings.

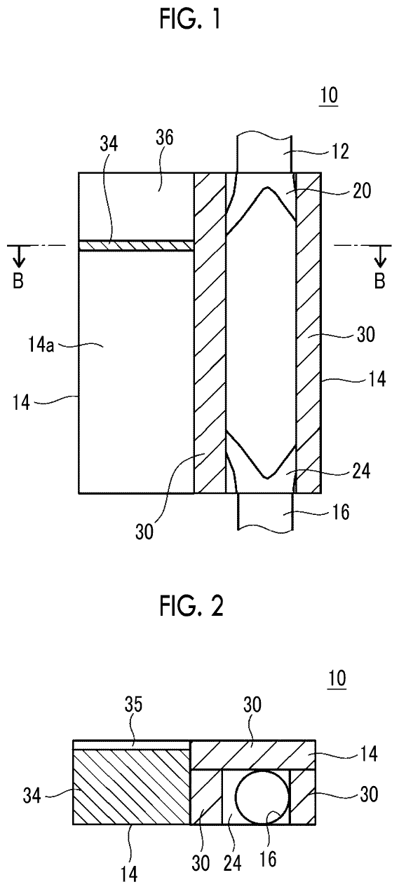

FIG. 1 is a schematic cross-sectional view showing an example of a ventilation-type silencer according to the embodiment of the present invention. FIG. 2 is a cross-sectional view taken along line B-B of FIG. 1.

The ventilation-type silencer 10 shown in FIG. 1 includes a tubular inlet-side vent pipe 12, an expansion section 14 that is connected to one opening end surface of the inlet-side vent pipe 12, a tubular outlet-side vent pipe 16 that is connected to an end surface of the expansion section 14 opposite to the inlet-side vent pipe 12, porous sound absorbing materials 30 that are disposed in some regions in the expansion section 14, a back space 14a that is a space in the expansion section 14 in which no porous sound absorbing material 30 is disposed and is positioned on a side opposite to the vent pipes, and a partition member 34 that partitions the back space 14a.

Further, as a preferred aspect, the ventilation-type silencer 10 shown in FIG. 1 includes a first opening structure 20 that is disposed at a connection portion of the expansion section 14 connected to the inlet-side vent pipe 12, and a second opening structure 24 that is disposed at a connection portion of the expansion section 14 connected to the outlet-side vent pipe 16. Hereinafter, the first opening structure 20 and the second opening structure 24 are collectively referred to as an opening structure.

The inlet-side vent pipe 12 is a tubular member and transports gas, which flows in from one opening end surface thereof, to the expansion section 14 connected to the other opening end surface thereof.

The outlet-side vent pipe 16 is a tubular member and transports gas, which flows in from one opening end surface thereof connected to the expansion section 14, to the other opening end surface thereof.

Cross-sectional shapes of the inlet-side vent pipe 12 and the outlet-side vent pipe 16 (hereinafter, collectively referred to as a vent pipe) may be various shapes, such as a circular shape, a rectangular shape, and a triangular shape. Further, the cross-sectional shape of the vent pipe may not be constant in an axial direction of a central axis of the vent pipe. For example, a diameter of the vent pipe may be changed in the axial direction.

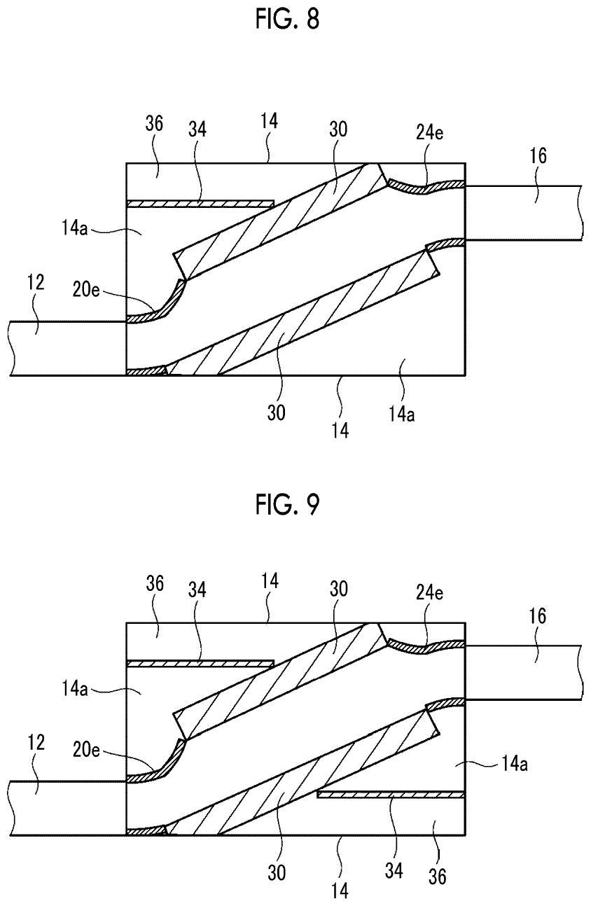

The inlet-side vent pipe 12 and the outlet-side vent pipe 16 may have the same cross-sectional shape and the same cross-sectional area, or may have different shapes and/or different cross-sectional areas. Further, in the example shown in FIG. 1, the inlet-side vent pipe 12 and the outlet-side vent pipe 16 are disposed such that central axes thereof coincide with each other. However, the present invention is not limited thereto, and the central axis of the inlet-side vent pipe 12 and the central axis of the outlet-side vent pipe 16 may be shifted from each other as in an example shown in FIG. 8 to be described later.

The sizes (cross-sectional areas, or the like) of the inlet-side vent pipe 12 and the outlet-side vent pipe 16 may be appropriately set according to the size of a device for which the ventilation-type silencer is used, required ventilation performance, and the like.

The expansion section 14 is disposed between the inlet-side vent pipe 12 and the outlet-side vent pipe 16, and transports gas, which flows in from the inlet-side vent pipe 12, to the outlet-side vent pipe 16.

The expansion section 14 has a cross-sectional area perpendicular to a flow channel direction that is larger than the cross-sectional area of the inlet-side vent pipe 12 and larger than the cross-sectional area of the outlet-side vent pipe 16. That is, in a case where, for example, each of the cross-sectional shapes of the inlet-side vent pipe 12, the outlet-side vent pipe 16, and the expansion section 14 is a circular shape, the diameter of the cross section of the expansion section 14 is larger than the diameters of the inlet-side vent pipe 12 and the outlet-side vent pipe 16.

The cross-sectional shape of the expansion section 14 may be various shapes, such as a circular shape, a rectangular shape, and a triangular shape. Further, the cross-sectional shape of the expansion section 14 may not be constant in an axial direction of a central axis of the expansion section 14. For example, the diameter of the expansion section 14 may be changed in the axial direction.

The size (the length, the cross-sectional area, or the like) of the expansion section 14 may be appropriately set according to the size of a device for which the ventilation-type silencer is used, required sound deadening performance, and the like.

In the example shown in FIGS. 1 and 2, the expansion section 14 has the shape of a hollow rectangular parallelepiped and the inlet-side vent pipe 12 is connected to one of the two surfaces of the expansion section 14, which that have the smallest area and face each other, and the outlet-side vent pipe 16 is connected to the other thereof. Further, as shown in FIG. 2, each vent pipe is connected at a position shifted from the center of the surface to which each vent pipe is connected. Specifically, in FIG. 2, the vent pipe is connected at a position close to a right surface in a horizontal direction, and is connected at a position close to a lower surface in a vertical direction.

The porous sound absorbing materials 30 are disposed in the expansion section 14. The porous sound absorbing materials 30 convert the sound energy of sound waves passing through the inside thereof into thermal energy to absorb the sound waves.

As shown in FIG. 1, the porous sound absorbing materials 30 are disposed along a region that serves as a flow channel connecting the inlet-side vent pipe 12 and the outlet-side vent pipe 16 in the expansion section 14. In the example shown in FIG. 1, as a preferred aspect, the ventilation-type silencer 10 includes the first opening structure 20 at the connection portion of the expansion section 14 connected to the inlet-side vent pipe 12 and includes the second opening structure 24 at the connection portion of the expansion section 14 connected to the outlet-side vent pipe 16. Accordingly, a region that linearly connects an end surface of the first opening structure 20 facing the outlet-side vent pipe 16 and an end surface of the second opening structure 24 facing the inlet-side vent pipe 12 is used as a flow channel, and the porous sound absorbing materials 30 are disposed to surround this flow channel. More specifically, as shown in FIG. 2, the porous sound absorbing materials 30 are disposed in the entire region between the upper largest surface of the expansion section 14 and the first opening structure 20 and the second opening structure 24, that is, a flow channel in FIG. 2, the entire region between the right surface of the expansion section 14 and the first opening structure 20 and the second opening structure 24 (flow channel) in FIG. 1, and a region formed along the flow channel on a side facing the first opening structure 20 and the second opening structure 24 between the left surface of the expansion section 14 and the first opening structure 20 and the second opening structure 24 (flow channel) in FIG. 1. Accordingly, the porous sound absorbing materials 30 are disposed not to block the vent pipes as viewed in the flow channel direction. Therefore, a region surrounded by the porous sound absorbing materials 30 acts as a flow channel (ventilation channel).

The porous sound absorbing material 30 is not particularly limited, and a sound absorbing material publicly known in the related art can be appropriately used. For example, various publicly known sound absorbing materials, such as a foam body, a foam material (urethane foam (for example, “CALMFLEX F-Series” manufactured by INOAC CORPORATION, urethane foam manufactured by Hikari Co., Ltd., “MIF” manufactured by Tokai Rubber Industries, Ltd., and the like), flexible urethane foam, a ceramic particle sintered material, phenol foam, melamine foam (“Basotect” (named “Basotect” in Japan) manufactured by BASF SE), polyamide foam, and the like), a nonwoven fabric-based sound absorbing material (a plastic nonwoven fabric, such as a microfiber nonwoven fabric (for example, “Thinsulate” manufactured by 3M Company, “MILIFE MF” manufactured by ENEOS Techno Materials Corporation, “Micromat” manufactured by TAIHEI FELT Co., Ltd., and the like), a polyester nonwoven fabric (for example, “White Kyuon” manufactured by TOKYO Bouon, “QonPET” manufactured by Bridgestone KBG Co., Ltd., and “SYNTHEFIBER” manufactured by Toray Industries, Inc.), and an acrylic fiber nonwoven fabric, a natural fiber nonwoven fabric, such as wool and felt, a metal nonwoven fabric, a glass nonwoven fabric, a cellulose nonwoven fabric, and the like), and a material including a minute amount of air (glass wool, rock wool, and a nanofiber-based fiber sound absorbing material (silica nanofiber and acrylic nanofiber (for example, “XAI” manufactured by Mitsubishi Chemical Corporation)) can be used.

Further, a sound absorbing material having a two-layer structure that includes a high-density thin surface nonwoven fabric and a low-density back nonwoven fabric may also be used.

The size, type, and the like of the porous sound absorbing material may be appropriately set according to sound deadening performance (a sound deadening frequency and the amount of deadened sound), the amount of ventilation, and the like required for the ventilation-type silencer.

The back space 14a that is a space in the expansion section 14 is formed on a side of the porous sound absorbing materials 30 opposite to the flow channel (hereinafter, referred to as a back side). Specifically, the back space 14a in which no porous sound absorbing material 30 is disposed is formed between the porous sound absorbing material 30, which is disposed in the region formed along the flow channel on a side facing the first opening structure 20 and the second opening structure 24 between the left surface of the expansion section 14 and the first opening structure 20 and the second opening structure 24 (flow channel) in FIG. 1, and the left surface of the expansion section 14.

In a case where the back side of the porous sound absorbing material is in direct contact with a wall as described above, sound waves entering the porous sound absorbing material from the ventilation channel are reflected by the wall and return to the flow channel. For this reason, a sound absorbing effect of the porous sound absorbing material is not likely to be sufficiently obtained. On the other hand, since the back space 14a is provided on the back side of the porous sound absorbing material 30, it is possible to inhibit the sound waves, which enter the porous sound absorbing material 30 from the flow channel, from being reflected and returning to the flow channel. For this reason, a sound deadening effect of the porous sound absorbing material 30 can be further improved.

Further, since a sound absorbing effect can be improved even though the amount of porous sound absorbing material 30 is reduced, it is also possible to reduce problems, such as the occurrence of mold when the sound absorbing material is wet with water, flammability, an increase in cost caused by the cost of the materials or the like, and an increase in dust, which occur in a case where the amount of porous sound absorbing material is large.

Here, in the present invention, the partition member 34 that partitions the back space 14a is disposed in the back space 14a. In the example shown in FIG. 1, the partition member 34 is a flat plate-like member and partitions the back space 14a into two spaces in the flow channel direction (a vertical direction in FIG. 1). The partition member 34 is disposed such that the largest surface of the partition member 34 is perpendicular to the largest surface of the expansion section 14 and perpendicular to the flow channel direction.

Further, the partition member 34 is disposed at a position where the volumes of the two partitioned spaces are different from each other.

One of the two spaces into which the back space 14a is partitioned by the partition member 34 functions as an acoustic resonator 36. In the example shown in FIG. 1, the upper space, which has a smaller volume, of the two spaces into which the back space 14a is partitioned by the partition member 34 functions as the acoustic resonator 36. As shown in FIG. 1, a side of the acoustic resonator 36 facing the porous sound absorbing material 30 is open and is acoustically connected to the flow channel via the porous sound absorbing material 30.

The space, which has a larger volume, of the two spaces that are partitioned by the partition member may function as an acoustic resonator and the space, which has a smaller volume, thereof may function as the back space.

For example, the acoustic resonator 36 acts as an air column resonator in a case where a standing wave is generated in a space including an opening. A resonance frequency of an air column resonator is matched to a frequency of sound desired to be deadened, so that the air column resonator can deaden the sound having the frequency.

In a case where the back space is provided on the back side of the porous sound absorbing material as described above, there is a problem in that sound deadening performance in a low frequency band is low. Specifically, in a case where the back space is provided on the back side of the porous sound absorbing material, it is found that a transmission loss (sound absorbing performance) is reduced in a certain frequency band over a low frequency band due to the influence of the back space.

On the other hand, in the ventilation-type silencer 10 according to the embodiment of the present invention, the partition member 34 for partitioning the back space 14a is disposed in the back space 14a and a region partitioned by the partition member 34 is caused to act as the acoustic resonator 36. The resonance frequency of the acoustic resonator 36 is matched to a frequency of sound desired to be deadened, that is, a frequency at which a transmission loss is reduced due to the influence of the back space, so that the sound having the frequency can be deadened and sound deadening performance can be improved.

Further, since the porous sound absorbing material 30 is disposed between the partition member 34 (acoustic resonator 36) and the flow channel, wind flowing through the flow channel is not direct contact with the partition member 34 (an opening portion of the acoustic resonator 36). Accordingly, the occurrence of a pressure loss and wind noise can be suppressed.

Furthermore, the frequency band of sound deadening of a resonator is generally narrow. However, since the porous sound absorbing material 30 is disposed to cover the opening portion of the acoustic resonator 36, the band of sound deadening of the acoustic resonator 36 can be widened (broadened).

In addition, in a case where the partition member 34 is provided in the expansion section 14 such that a housing (wall) of the expansion section 14 and the partition member 34 adhere to each other or are integrated with each other, the strength of the expansion section 14 having a large space can be increased. Accordingly, even in a case where the expansion section 14 is made of a resin, sufficient strength can be ensured.

The thickness of the porous sound absorbing material 30 in a direction orthogonal to the flow channel direction may be appropriately set to a thickness at which desired sound deadening performance is obtained according to the flow resistance, the porosity, the tortuosity, or the like of the porous sound absorbing material 30. From the viewpoint of sound deadening performance, the thickness of the porous sound absorbing material 30 in a direction orthogonal to the flow channel direction is preferably in a range of 3 mm to 50 mm, more preferably in a range of 10 mm to 30 mm, and most preferably in a range of 9 mm to 20 mm.

Further, from the viewpoint of sound deadening performance, the depth of the back space 14a in a direction orthogonal to the flow channel direction is preferably in a range of 30 mm to 400 mm and more preferably in a range of 50 mm to 200 mm. Furthermore, from the viewpoint of sound deadening performance, the depth of the back space 14a is preferably two to twenty times the thickness of the porous sound absorbing material 30 and more preferably three to ten times the thickness of the porous sound absorbing material 30.

Here, the partition member 34 is a flat plate-like member in the example shown in FIGS. 1 and 2, but the present invention is not limited thereto. An acoustic resonator 36 having a sound deadening effect in a desired frequency band may have only to be capable of being formed, and, for example, at least a part of the acoustic resonator 36 may have a curved shape, a shape including a bent portion, a zigzag shape, or a complicated shape such as a maze shape.

Further, the resonance of the acoustic resonator 36 is air column resonance in the example shown in FIG. 1, but the present invention is not limited thereto. The resonance of the acoustic resonator may be Helmholtz resonance.

Helmholtz resonance is a structure in which air in an internal space acts as a spring and air in an opening portion acts as mass due to thermodynamic expansion and compression, mass-spring resonance occurs, and sound is absorbed due to thermal viscous friction near a wall of the opening portion. Even though various shapes, such as a circular shape, a rectangular shape, and a slit shape, are employed as the shape of the opening portion, resonance can be made to occur. Further, a plurality of opening portions may be provided.

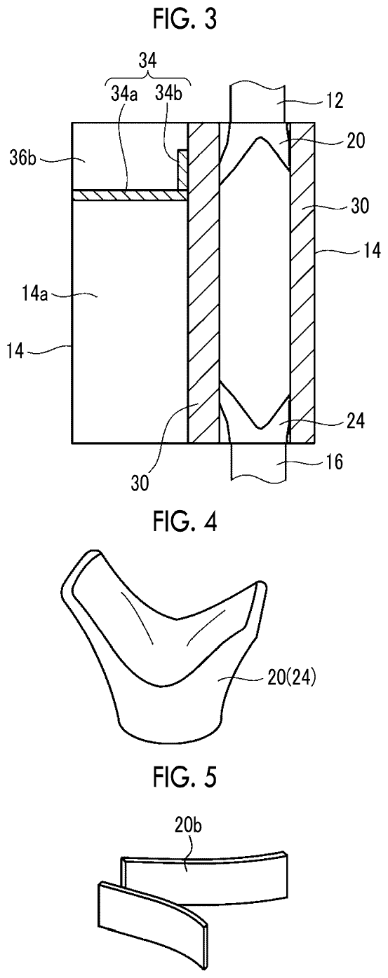

In a case where the resonance of the acoustic resonator is Helmholtz resonance, it is preferable that a partition member 34 includes a part protruding toward an acoustic resonator 36b at an end portion thereof facing the porous sound absorbing material 30 as in an example shown in FIG. 3. The partition member 34 of the example shown in FIG. 3 includes a plate-like member 34b that is provided at an end portion of the largest surface of a plate-like member 34a facing the porous sound absorbing material 30, has a width identical to the width of the plate-like member 34a in a direction perpendicular to the plane of paper in FIG. 3, and stands in the acoustic resonator 36b. An end surface of the plate-like member 34b opposite to the plate-like member 34a is not in contact with the wall (an upper wall in FIG. 3) of the expansion section 14, and includes an opening portion formed therein. In the example shown in FIG. 3, the opening portion of the acoustic resonator 36b is narrowed by the plate-like member 34b as compared to the example shown in FIG. 1. Since the opening portion of the acoustic resonator 36b is narrowed as described above, the resonance of the acoustic resonator 36b can be Helmholtz resonance.

A resonance frequency of air column resonance depends on the length of a resonance tube. Since the length of the resonance tube needs to be further increased in a case where the resonance frequency is to be lowered, the resonance tube is increased in size. On the other hand, a resonance frequency of Helmholtz resonance depends on the volume of the internal space and the area and length of the opening portion. For this reason, Helmholtz resonance is preferable in that the resonance frequency can be lowered without an increase in size in a case where the volume of the internal space and the area and length of the opening portion are appropriately set.

The size (the depth, width, volume, or the like) of the acoustic resonator 36, which is partitioned and formed by the partition member 34, and the size of the opening portion may be appropriately set according to the size and shape of the expansion section 14, and the type, resonance frequency, and the like of the resonance of the acoustic resonator 36. That is, the partition member 34 may be disposed such that the size of the acoustic resonator 36 and the size of the opening portion are set to desired sizes.

The resonance frequency of the acoustic resonator is preferably 2000 Hz or less, more preferably in a range of 100 Hz to 1800 Hz, and still more preferably in a range of 200 Hz to 1500 Hz.

Further, in the examples shown in FIGS. 1 and 3, as a preferred aspect, the partition member 34 is in contact with the porous sound absorbing material 30. Accordingly, since the partition member 34 supports the porous sound absorbing material 30, the position of the porous sound absorbing material 30 can be held at an appropriate position even in a configuration in which the back space 14a is provided.

Furthermore, it is preferable that the ventilation-type silencer according to the embodiment of the present invention is adapted such that at least one of the walls forming the expansion section 14 vibrates and sound having a natural frequency of this vibration is deadened.

At least one of the walls forming the expansion section 14 vibrates, and vibrates significantly particularly at the natural frequency of the wall. As a configuration in which sound having this frequency is deadened, the natural frequency of the wall is matched to a frequency of sound desired to be deadened, so that the sound having the frequency can be deadened and sound deadening performance can be improved.

It is possible to adjust the natural frequency of the wall by appropriately setting the thickness, hardness, and size of the wall, a method of fixing the wall, and the like. Further, it is also possible to adjust the natural frequency of the wall by mounting a weight on the wall.

The lowest natural frequency of the wall is preferably a low frequency of 2000 Hz or less, more preferably in a range of 100 Hz to 1500 Hz, and still more preferably in a range of 200 Hz to 1000 Hz. Accordingly, it is possible to improve sound deadening performance in a low frequency band in which it is difficult for sound to be deadened by the porous sound absorbing material 30.

It is preferable that a wall to vibrate is a wall having the largest area among the walls forming the expansion section 14. Accordingly, a sound deadening frequency caused by the vibration of the wall can be further lowered. In the example shown in FIGS. 1 and 2, it is preferable that an upper wall or a lower wall in FIG. 2 vibrates.

Further, from the viewpoint that the wall can easily vibrate, it is preferable that a wall to vibrate has a flat surface. As described above, various shapes, such as a circular shape, a rectangular shape, and a triangular shape, can be used as the cross-sectional shape of the expansion section 14 and a wall of the expansion section 14 may be curved. However, since it is difficult for a curved wall to vibrate, it is preferable that the expansion section 14 includes a wall having a flat shape.

Furthermore, from the viewpoint of not restricting the vibration of a wall and lowering a natural frequency, it is preferable that the partition member 34 does not adhere to at least one of two walls surrounding the acoustic resonator 36 and facing each other among walls of the expansion section 14.

In the example shown in FIG. 2, as a preferred aspect, a gap 35 is formed between the upper wall and the partition member 34 in FIG. 2 and the upper wall and the partition member 34 do not adhere to each other. In FIG. 2, the upper wall is a wall that surrounds the acoustic resonator 36 and faces the lower wall surrounding the acoustic resonator 36 likewise. The lower wall and the partition member 34 adhere to each other or are integrally formed. In the case of the example shown in FIG. 2, the upper wall and the lower wall in FIG. 2 are the largest surfaces of the walls forming the expansion section 14. Since the partition member 34 and the upper wall do not adhere to each other, the restriction of the vibration of the upper wall is suppressed and the upper wall is likely to vibrate. Further, the natural frequency of the upper wall can be lowered, and sound having a low frequency (sound having the natural frequency of the wall) can be deadened by the vibration of the upper wall. Furthermore, it is preferable that the partition member 34 does not adhere to the surface having the largest area as in the example shown in FIG. 2.

A distance between the partition member 34 and the wall that does not adhere (in FIG. 2, the width of the gap 35 in the vertical direction) is preferably 5 mm or less and more preferably in a range of 1 mm to 3 mm. Accordingly, in a case where the gap is small, it is difficult for sound to pass due to thermal viscous sound (thermal friction caused by vibration). Therefore, acoustic resonance can be maintained. Accordingly, it is desirable that the width of the gap is 5 mm or less. Further, in a case where the gap is excessively small, there is a concern that the partition member 34 and the wall that not adhere collide with each other due to the vibration, wobble, or the like of the housing, noise is caused, or damage occurs. Accordingly, it is preferable that the width of the gap is 1 mm or more.

In a case where a distance between the partition member 34 and the wall that does not adhere is not constant, the distance is measured at five or more points arranged at regular intervals and it may be sufficient that an average value of the measured values is in the range described above.

Further, the partition member 34 may adhere to (be integrated with) both two walls that surround the acoustic resonator 36 and face each other among the walls of the expansion section 14. In this case, it is preferable that the lowest natural frequency of a flat surface (wall) after the ventilation-type silencer is formed to include the partition member is 2000 Hz or less.

Furthermore, the acoustic resonator 36 is formed on one end portion side of the expansion section 14 in the flow channel direction as a preferred aspect in the examples shown in FIGS. 1 and 3, but the present invention is not limited thereto. The acoustic resonator 36 may be formed at any position in the expansion section 14 in the flow channel direction. In other words, in the examples shown in FIGS. 1 and 3, the ventilation-type silencer includes one partition member 34 and the space, which is formed by the partition member 34 and the walls surrounding the expansion section 14 in four directions, is used as the acoustic resonator 36. However, the present invention is not limited thereto. For example, in FIG. 1, the ventilation-type silencer may include another partition member that is disposed in the expansion section 14 at a position shifted from the partition member 34 in the flow channel direction in parallel to the partition member 34, and a space, which is formed by the two partition members and the walls surrounding the expansion section 14 in three directions, may be used as the acoustic resonator 36.

Since the acoustic resonator 36 is formed on one end portion side of the expansion section 14 in the flow channel direction, it is difficult to restrict the vibration of the wall which the partition member 34 adheres to or is integrated with and it is possible to increase the size of the surface that substantially vibrates. As a result, the natural frequency of the wall can be lowered.

For example, a plurality of (six in the example shown in FIG. 1) plates may be disposed in a box shape, and the plates adjacent to each other may be joined to each other by an adhesive, a pressure sensitive adhesive, solder, fusion welding, or the like to form the expansion section 14. Alternatively, in a case where the expansion section 14 is divided into two pieces and fragmented, each fragment may be produced using injection molding, a 3D printer, or the like and the fragments may be combined with each other to form the expansion section 14. Further, the partition member 34 and the walls of the expansion section 14 may be joined to each other by an adhesive, a pressure sensitive adhesive, solder, fusion welding, or the like or may be integrally formed. For example, in a case where the fragments of the expansion section 14 are to be produced using injection molding, a 3D printer, or the like, the partition member 34 may be integrated with the fragments of the expansion section 14 and the integrated fragments may be produced using injection molding, a 3D printer, or the like.

For example, in a case where the expansion section 14 and the partition member 34 of the ventilation-type silencer 10 shown in FIGS. 1 and 2 are to be integrated with each other, a plate serves as an upper wall of the expansion section 14 in FIG. 2 and a portion other than the plate are divided into two pieces and fragmented, a fragment in which the portion of the expansion section 14 except for the upper wall is integrated with the partition member 34 can be produced using injection molding, a 3D printer, or the like, and the plate serving as the upper wall is joined to this fragment. As a result, the expansion section 14 in which the partition member 34 is disposed can be produced.

In a case where the partition member 34 and the expansion section 14 are to be integrated with each other, it is preferable that the thickness of the partition member 34 is constant or monotonically reduced in at least one direction of directions away from the wall from a position at which the partition member 34 is joined to the wall of the expansion section 14.

For example, in a case where the portion of the expansion section 14 except for the upper wall and the partition member 34 are to be integrally formed in the example shown in FIG. 2, it is preferable that the thickness of the partition member 34 is constant or monotonically reduced in a direction away from the lower wall joined to the partition member 34, that is, toward the upper side in FIG. 2.

Accordingly, for example, in a case where the fragment in which the portion of the expansion section 14 except for the upper wall is integrated with the partition member 34 is produced using injection molding, the fragment can be pulled out from a mold and is easily pulled out. Further, for example, in a case where the fragment in which the portion of the expansion section 14 except for the upper wall is integrated with the partition member 34 is produced using a 3D printer, the fragment is easily produced since a layer is easily laminated.

Further, from the viewpoint of easily producing a fragment using injection molding or a 3D printer, it is preferable that at least one surface of the expansion section 14 is a flat surface.

Furthermore, from the viewpoint of easily producing a fragment using injection molding or a 3D printer, it is preferable that all sides of the partition member 34 are straight.

The partition member 34 may be produced as a member separate from the expansion section 14 and adhere to the wall of the expansion section 14. Alternatively, a claw portion, a groove, or the like may be provided on the wall of the expansion section 14 and the partition member 34 may be fitted to the claw portion, the groove, or the like.

Examples of a material for forming the vent pipe, the expansion section, and the partition member can include a metal material, a resin material, a reinforced plastic material, a carbon fiber, and the like. Examples of the metal material can include metal materials, such as aluminum, titanium, magnesium, tungsten, iron, steel, chromium, chromium molybdenum, nichrome molybdenum, and alloys thereof. Further, examples of the resin material can include resin materials, such as an acrylic resin (PMMA), polymethyl methacrylate, polycarbonate, polyamide-imide, polyarylate, polyetherimide, polyacetal, polyetheretherketone, polyphenylene sulfide, polysulfone, polyethylene terephthalate, polybutylene terephthalate (PBT), polyimide, triacetylcellulose (TAC), polypropylene (PP), polyethylene (PE), polystyrene (PS), an acrylonitrile butadiene styrene copolymer (ABS resin), a flame-retardant ABS resin, an acrylic styrene acrylonitrile copolymer (ASA resin), a polyvinyl chloride (PVC) resin, and a polylactic acid (PLA) resin. Furthermore, examples of the reinforced plastic material can include carbon fiber reinforced plastics (CFRP) and glass fiber reinforced plastics (GFRP).

From the viewpoint of a reduction in weight, the case of molding, and the like, it is preferable that a resin material is used as the material of the ventilation-type silencer.

It is desirable that these materials have incombustibility, flame retardance, and self-extinguishing properties. Further, it is also preferable that the entire ventilation-type silencer has incombustibility, flame retardance, and self-extinguishing properties.

Here, as a preferred aspect, the ventilation-type silencer 10 shown in FIGS. 1 and 2 includes opening structures, which have a cross-sectional area gradually increased from the connection portion toward the inside of the expansion section 14, at the connection portion of the expansion section 14 connected to the inlet-side vent pipe 12 and the connection portion of the expansion section 14 connected to the outlet-side vent pipe 16. FIG. 4 shows a perspective view of the opening structure (20, 24).

The first opening structure 20 is a tapered tubular member that is disposed in contact with the connection portion of the expansion section 14 connected to the inlet-side vent pipe 12 and has an opening area gradually increased from an inlet-side vent pipe 12 side toward an outlet-side vent pipe 16 side.

In the example shown in FIG. 1, the shape and area of an opening of the first opening structure 20 facing the inlet-side vent pipe 12 side (hereinafter, referred to as a proximal end side) substantially coincide with the cross-sectional shape and the cross-sectional area of the inlet-side vent pipe 12. Further, the shape and area of an opening of an end surface of the first opening structure 20 facing the outlet-side vent pipe 16 side (hereinafter, referred to as a distal end side) substantially coincide with the cross-sectional shape and the cross-sectional area of a substantially rectangular flow channel that is surrounded by the porous sound absorbing materials 30 and the wall of the expansion section 14. That is, the first opening structure 20 is in substantial contact with the porous sound absorbing materials 30 and the wall of the expansion section 14 at the end surface thereof facing the outlet-side vent pipe 16 side.

As shown in FIG. 4, the first opening structure 20 is a trumpet-shaped tubular member that has a cross-sectional area gradually increased from the proximal end side toward the distal end side.

The second opening structure 24 is a tapered tubular member that is disposed in contact with the connection portion of the expansion section 14 connected to the outlet-side vent pipe 16 and has an opening area gradually reduced from the inlet-side vent pipe 12 toward the outlet-side vent pipe 16.

In the example shown in FIG. 1, the shape and area of an opening of the second opening structure 24 facing the outlet-side vent pipe 16 side (hereinafter, referred to as a proximal end side) substantially coincide with the cross-sectional shape and the cross-sectional area of the outlet-side vent pipe 16. Further, the shape and area of an opening of an end surface of the second opening structure 24 facing the inlet-side vent pipe 12 side (hereinafter, referred to as a distal end side) substantially coincide with the cross-sectional shape and the cross-sectional area of a substantially rectangular flow channel that is surrounded by the porous sound absorbing materials 30 and the wall of the expansion section 14. That is, the second opening structure 24 is in substantial contact with the porous sound absorbing materials 30 and the wall of the expansion section 14 at an end surface thereof facing the inlet-side vent pipe 12 side.

As shown in FIG. 4, the second opening structure 24 is a trumpet-shaped tubular member that has a cross-sectional area gradually increased from the proximal end side toward the distal end side.

In the ventilation-type silencer 10 including the expansion section 14, a horn-shaped member (opening structure) having a cross-sectional area gradually increased toward the inside of the expansion section 14 is disposed at each of the inlet and outlet of the expansion section 14. Accordingly, the disturbance of the flow of wind to flow into the expansion section 14 or to be discharged is suppressed, so that a sound deadening effect can be improved.

Here, the first opening structure 20 and the second opening structure 24 are trumpet-shaped tubular members having a cross-sectional area gradually increased from the proximal end side toward the distal end side in the example shown in FIG. 4, but the present invention is not limited thereto. As long as the opening structure has a cross-sectional area gradually changing, the shape of the opening structure is not particularly limited. Another example of each of the first opening structure 20 and the second opening structure 24 will be described below.

An opening structure 20b shown in FIG. 5 includes two curved plate-like members, and a width between the two plate-like members is gradually increased from one end portion toward the other end portion. Further, the opening structure 20b is open in a vertical direction in FIG. 5, and may be in contact with, for example, the wall of the expansion section 14 or the porous sound absorbing materials 30.

Furthermore, the opening structure may be only one of the plate-like members shown in FIG. 5. A wall is provided on one side and a curved plate-like member is provided on the other side, so that an opening structure having a cross-sectional area gradually changing can be realized.

As described above, the opening structure may not be closed in a cross section of an end portion thereof facing the other vent pipe. That is, the first opening structure may not be closed in the cross section of the end portion thereof facing the outlet-side vent pipe, and the second opening structure may not be closed in the cross section of the end portion thereof facing the inlet-side vent pipe.

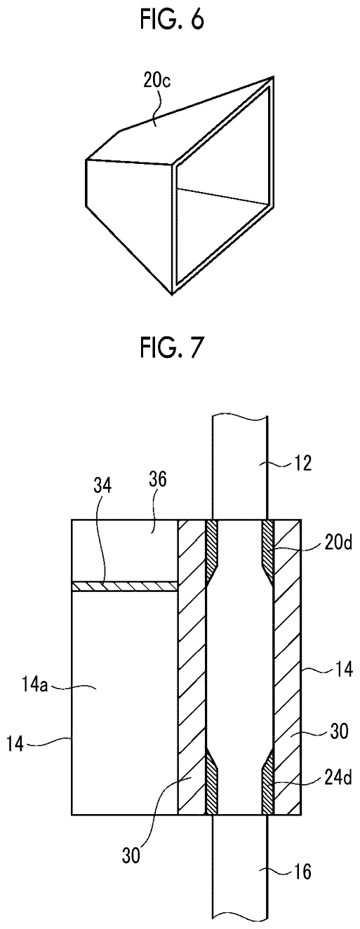

An opening structure 20c shown in FIG. 6 has a rectangular cross-sectional shape, and has a shape in which a cross-sectional area is increased along a central axis while a similar shape is maintained. That is, the opening structure 20c has a truncated square pyramid shape, and includes an opening penetrating a lower base from an upper base.

Further, the opening structure is not limited to a shape in which a cross-sectional shape is increased as in each example described above, and may have a configuration in which a wall thickness of an end portion of an opening structure (20d, 24d) is gradually reduced as in a ventilation-type silencer shown in FIG. 7. That is, a first opening structure 20d has a cross-sectional shape identical to the cross-sectional shape of the inlet-side vent pipe 12, and a wall thickness of an end portion thereof facing the outlet-side vent pipe 16 is gradually reduced toward the outlet-side vent pipe 16. Further, a second opening structure 24d has a cross-sectional shape identical to the cross-sectional shape of the outlet-side vent pipe 16, and a wall thickness of an end portion thereof facing the inlet-side vent pipe 12 is gradually reduced toward the inlet-side vent pipe 12. The first opening structure 20d and the inlet-side vent pipe 12 may be integrally formed. Furthermore, the second opening structure 24d and the outlet-side vent pipe 16 may be integrally formed.

For example, in a case where an inner diameter of each of the inlet-side vent pipe 12 and the outlet-side vent pipe 16 is 30 mm and a wall thickness thereof is 2 mm in an example shown in FIG. 7, a ratio of an area corresponding to an inner diameter (diameter 34 mm) of a distal end portion (facing the other vent pipe) of each of the first opening structure 20d and the second opening structure 24d to an area corresponding to an inner diameter of a proximal end portion (facing the connected vent pipe) thereof is 1.28. In a case where the wall thickness is 3 mm, a ratio of an area corresponding to an inner diameter of a distal end portion thereof to an area corresponding to an inner diameter of a proximal end portion thereof is 1.44 and the cross-sectional area of each of the first opening structure 20d and the second opening structure 24d is sufficiently changed. In a case where the first opening structure 20d and the second opening structure 24d include regions having a wall thickness gradually reduced as in the example shown in FIG. 7, a change in cross-sectional area can be made gentle and wind noise can be reduced. Further, although it is desirable that the outer shape of the expansion section 14 is kept constant and the inside thereof is gradually widened, the distal end portions of the opening structures may be made thin and pointed.

Furthermore, each of the first opening structure 20d and the second opening structure 24d may include a region in which the wall thickness is constant and which has a certain length and include a region in which the wall thickness is gradually reduced on a distal end side thereof as in the example shown in FIG. 7, or may be formed of only a region in which the wall thickness is gradually reduced.

In addition, the wall thickness of an end portion of the opening structure of which a cross-sectional shape (outer shape) expands as the examples shown in FIGS. 4 to 6 may be gradually reduced.

As long as the opening structure has a cross-sectional area gradually changing as described above, the shape of the opening structure may be various shapes.

The cross-sectional shape of the proximal end side of the opening structure may be a shape matching the cross-sectional shape of the vent pipe, and the cross-sectional shape of the distal end side thereof may be a shape matching the cross-sectional shape of the flow channel that is surrounded by the wall of the expansion section 14 and/or the porous sound absorbing materials 30.

The cross-sectional shape of the opening structure perpendicular to a central axis preferably has a two-or-more-fold symmetry and more preferably has a four-or-more-fold symmetry.

Further, a change in cross-sectional area caused by the opening structure may be a monotonic change, may be a change in a rate of change, or may be a stepwise change.

Furthermore, an average roughness Ra of an inner surface (a surface facing the central axis) of the opening structure is preferably 1 mm or less, more preferably 0.5 mm or less, and still more preferably 0.1 mm or less. In a case where the average roughness Ra of the inner surface of the opening structure is reduced, it is possible to suppress the occurrence of wind noise that is caused in a case where wind flowing along the surface of the opening structure is separated and vortices are generated.

In addition, the central axes of the inlet-side vent pipe 12 and the outlet-side vent pipe 16 are disposed on the same straight line in the example shown in FIG. 1 and the like, but the present invention is not limited thereto. For example, the central axes of the inlet-side vent pipe 12 and the outlet-side vent pipe 16 may not be disposed on the same straight line as in examples shown in FIGS. 8 and 9. Even in the case of such a configuration, a configuration in which a partition member 34 for partitioning the back space 14a is disposed in the back space 14a can be employed as a configuration in which the back space 14a is formed on the back side of the porous sound absorbing materials 30 disposed in the expansion section 14.

Further, in the examples shown in FIGS. 8 and 9, as a preferred aspect, a first opening structure and a second opening structure are provided. In the examples shown in FIGS. 8 and 9, each of the first opening structure and the second opening structure is a structure in which a cross-sectional area changes and has a function of bending a flow channel.

In the example shown in FIG. 8, the first opening structure 20e has a configuration in which two plate-like members are disposed to face each other, the two plate-like members are curved such that the flow channel is bent to a direction in which the inlet-side vent pipe 12 and the outlet-side vent pipe 16 are connected to each other, and a widening structure (curved structure) at which a cross-sectional area changes is provided on a distal end side (the outlet-side vent pipe 16 side) of one plate-like member. Further, a second opening structure 24c has a configuration in which two plate-like members are disposed to face each other, the two plate-like members are curved such that the flow channel is bent from a direction in which the inlet-side vent pipe 12 and the outlet-side vent pipe 16 are connected to each other to a flow direction of the outlet-side vent pipe 16, and a widening structure (curved structure) at which a cross-sectional area changes is provided on a distal end side (the inlet-side vent pipe 12 side) of one plate-like member. In the example shown in FIG. 8, each of the first opening structure 20e and the second opening structure 24e has a configuration in which one plate-like member has a widening structure at which a cross-sectional area changes. However, each of the first opening structure 20e and the second opening structure 24e may have a configuration in which both the plate-like members have a widening structure (curved structure) at which a cross-sectional area changes.

Furthermore, the opening structure can have a configuration in which the curvature radii of the two plate-like members are different from each other or the lengths thereof are changed such that the cross-sectional area gradually changes.

As described above, the ventilation-type silencer shown in FIG. 8 has a configuration in which the central axes of the inlet-side vent pipe 12 and the outlet-side vent pipe 16 are not positioned on the same straight line and the flow channel is bent by the opening structure.

The ventilation-type silencer shown in FIG. 8 includes porous sound absorbing materials 30 that are disposed in the expansion section 14 along the flow channel from the distal end side of the first opening structure 20e to the distal end of the second opening structure 24c. Further, back spaces 14a are formed on the back side of the porous sound absorbing materials 30. In the example shown in FIG. 8, the back spaces 14a are formed on the upper left side and the lower right side in the expansion section 14 in FIG. 8.

A partition member 34 that partitions the back space 14a is disposed in the back space 14a. In the example shown in FIG. 8, the partition member 34 is disposed in the back space 14a formed on the upper left side in the expansion section 14 in FIG. 8. The partition member 34 is a flat plate-like member, extends in a horizontal direction in FIG. 8, and is disposed such that one end portion thereof is in contact with the wall of the expansion section 14 and the other end portion thereof is in contact with the porous sound absorbing material 30.

One of the two spaces into which the back space 14a is partitioned by the partition member 34 functions as an acoustic resonator 36. In the example shown in FIG. 8, an upper space of two spaces into which the back space 14a is partitioned by the partition member 34 functions as the acoustic resonator 36. As shown in FIG. 8, the acoustic resonator 36 is open on a side thereof facing the porous sound absorbing material 30, and is acoustically connected to the flow channel via the porous sound absorbing material 30. The acoustic resonator 36 acts as, for example, an air column resonator.

The partition member 34 for partitioning the back space 14a is disposed in one back space 14a of the two back spaces 14a in the example shown in FIG. 8, but the present invention is not limited thereto. As in the example shown in FIG. 9, the partition member 34 may be disposed in each of the two back spaces 14a and the ventilation-type silencer may include two acoustic resonators 36.

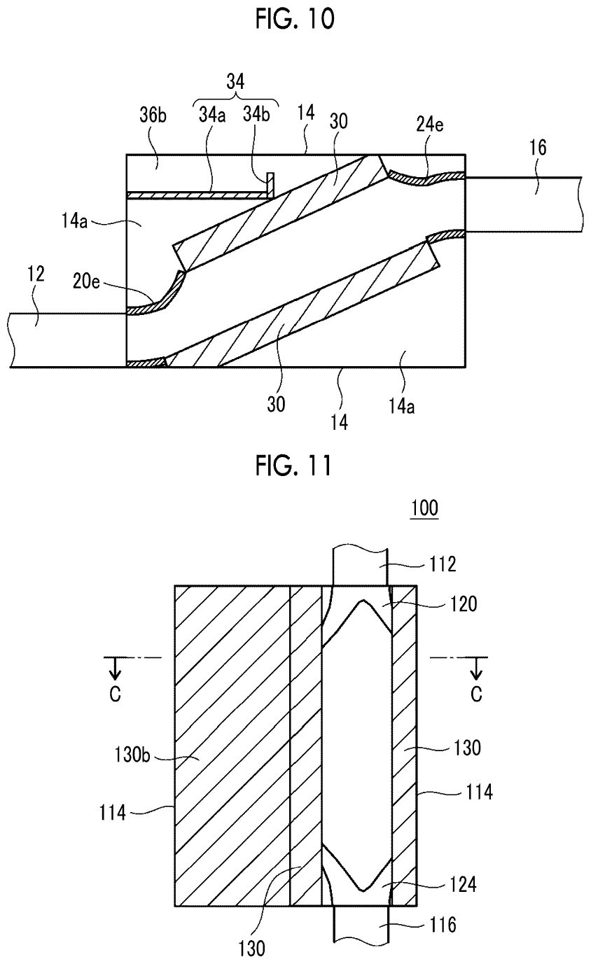

Further, in the examples shown in FIGS. 8 and 9, the partition member 34 is a flat plate-like member and the acoustic resonator 36 functions as an air column resonator. However, the present invention is not limited thereto. As in an example shown in FIG. 10, a partition member 34 may include a part that protrudes toward an acoustic resonator 36b at an end portion thereof facing the porous sound absorbing material 30. The partition member 34 of the example shown in FIG. 10 includes a plate-like member 34b that is provided at an end portion of the largest surface of a plate-like member 34a facing the porous sound absorbing material 30, has a width identical to the width of the plate-like member 34a in a direction perpendicular to the plane of paper in FIG. 10, and stands in the acoustic resonator 36b. An end surface of the plate-like member 34b opposite to the plate-like member 34a is not in contact with the wall (an upper wall in FIG. 10) of the expansion section 14, and includes an opening portion formed therein. The opening portion of the acoustic resonator 36 is narrowed by the plate-like member 34b in the example shown in FIG. 10 as compared to the example shown in FIG. 1. Since the opening portion of the acoustic resonator 36 is narrowed in this way, the resonance of the acoustic resonator 36b can be Helmholtz resonance.

Furthermore, even in a configuration in which the central axes of the inlet-side vent pipe 12 and the outlet-side vent pipe 16 are not positioned on the same straight line, the opening structure may include a region in which a wall thickness is gradually reduced so that a cross-sectional area gradually changes.

In addition, it is preferable that the ventilation-type silencer according to the embodiment of the present invention does not include a punched metal between the porous sound absorbing material and the flow channel. In a case where the ventilation-type silencer includes the punched metal between the porous sound absorbing material and the flow channel, wind flowing through the flow channel comes into direct contact with a step of a hole of the punched metal. Accordingly, there is a concern that a pressure loss may occur or wind noise may occur. Further, since an area where the porous sound absorbing material and sound come into contact with each other is reduced, there is a concern that the sound deadening effect of the porous sound absorbing material may be reduced.

Furthermore, it is preferable that the ventilation-type silencer according to the embodiment of the present invention does not include a punched metal even on a surface of the porous sound absorbing material opposite to the flow channel. That is, it is preferable that the ventilation-type silencer does not include a punched metal between the porous sound absorbing material and the back space and the acoustic resonator. In a case where the ventilation-type silencer includes the punched metal between the porous sound absorbing material and the back space, there is a concern that the above-described effect of improving sound deadening performance by providing the back space on the back side of the porous sound absorbing material may not be obtained.

In addition, in a case where it is assumed that the ventilation-type silencer according to the embodiment of the present invention is used in a state where the ventilation-type silencer is connected to a hose, it is desirable that outer peripheral surfaces of the inlet-side vent pipe and the outlet-side vent pipe of the ventilation-type silencer have an uneven shape and/or a bellows shape. Since the ventilation-type silencer is firmly tightened in a case where the ventilation-type silencer is connected to the hose, wind leakage, sound leakage, sound reflection, and the like can be prevented.

### EXAMPLES

The present invention will be described in more detail below on the basis of Examples. Materials, used amounts, ratios, treatment contents, treatment procedures, and the like described in the following examples can be appropriately changed without departing from the spirit of the present invention. Accordingly, the scope of the present invention should not be interpreted to be limited by the following examples.

### Comparative Example 1

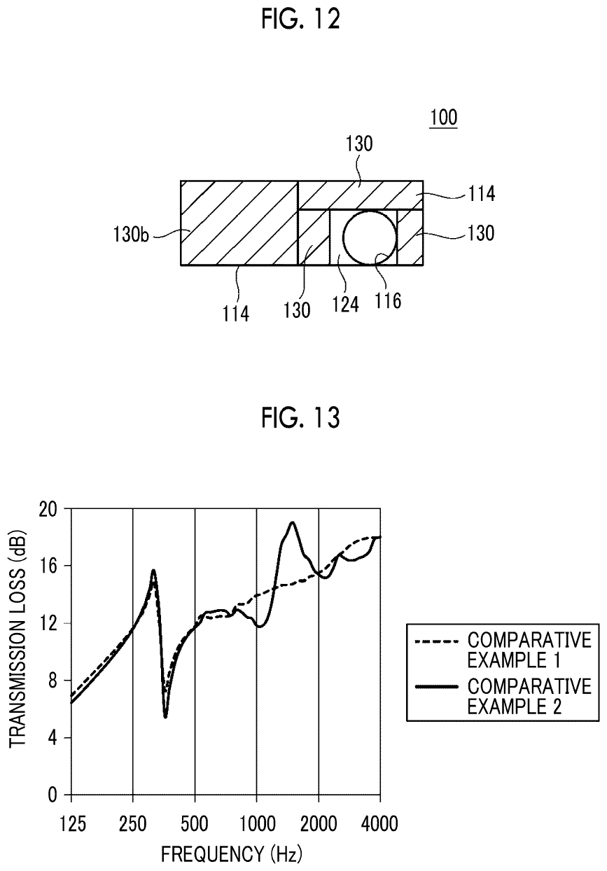

As shown in FIGS. 11 and 12, a ventilation-type silencer 100 in which an expansion section 114 was filled with porous sound absorbing materials 130 and 130b was produced. FIG. 11 is a cross-sectional view conceptually showing a ventilation-type silencer of Comparative Example. FIG. 12 is a cross-sectional view taken along line C-C of FIG. 11. The ventilation-type silencer 100 shown in FIGS. 11 and 12 has the same configuration as the ventilation-type silencer 10 according to the embodiment of the present invention shown in FIGS. 1 and 2, except that the partition member 34 is not provided and the back space 14a is filled with the porous sound absorbing material 130b.

An inner size of the expansion section 114 was set to a size of 105 mm in width×37 mm in height×140 mm in length. Further, inner diameters of vent pipes to be connected (an inlet-side vent pipe 112 and an outlet-side vent pipe 116) were set to 24 mm. A first opening structure 120 was disposed at a connection portion of the expansion section 114 connected to the inlet-side vent pipe 112, and a second opening structure 124 was disposed at a connection portion thereof connected to the outlet-side vent pipe 116. Each of the first opening structure 120 and the second opening structure 124 is two-dimensionally widened in a width direction, a width thereof on a proximal end side was 24 mm, a width thereof on a distal end side was 30 mm, and a length thereof in a length direction was 25 mm at the maximum.

One wall of the expansion section 114 in a height direction was divided into two parts, that is, a wall part and a main body part as separate parts (fragments), and each of the parts was produced by injection molding. Further, each of the two opening structures and the two vent pipes was also produced by injection molding. An ABS resin was used as a material of each member. The thickness of the wall part was set to 2 mm, and the thickness of the other member was set to 5 mm. Through-holes having a diameter of 24 mm to be connected to the vent pipes were formed in two walls of the main body part of the expansion section 114 in the length direction, respectively. The opening structures and the vent pipes adhered to the positions of the through-holes of the main body part of the expansion section 114.

Spaces except for a region (a region in which distal ends of the two opening structures are connected to each other) serves as a flow channel were filled with porous sound absorbing materials 130 and 130b (QonPET manufactured by Bridgestone KBG Co., Ltd.) in the main body part of the expansion section 114. QonPET had a structure in which a nonwoven fabric layer having a high density and a small thickness and a nonwoven fabric layer having a low density and a large thickness were joined to each other, and the nonwoven fabric layer having a high density was disposed to face a flow channel side.

The expansion section 114 was filled with the porous sound absorbing materials and the wall part then adhered to an opening surface of the main body part, so that the ventilation-type silencer 100 was produced. An adhesive CA-243 for ABS manufactured by CEMEDINE CO., LTD. was used as an adhesive.

### Comparative Example 2

A ventilation-type silencer was produced in the same manner as in Comparative Example 1 except that a porous sound absorbing material 130b was removed and a back space was formed in Comparative Example 1.

The porous sound absorbing material 130b is a part that is disposed on the back side of the porous sound absorbing material 130 and has a size of 50 mm in width×37 mm in height×140 mm in length. Therefore, the ventilation-type silencer of Comparative Example 2 includes a back space having a size of 50 mm in width×37 mm in height×140 mm in length.

### Example 1

A ventilation-type silencer (see FIGS. 1 and 2) having the same structure as that of Comparative Example 2, except that the partition member 34 was disposed in the back space, was produced.

The ventilation-type silencer of Example 1 was produced in the same manner as in Comparative Example 1 except that the partition member 34 was a flat plate-like member having a thickness of 3 mm, a width of 50 mm, and a height of 35 mm, was disposed at a position away from the wall in the length direction of the main body part of the expansion section 14 by a distance of 30 mm, and was integrally molded with the main body part of the expansion section 14 by injection molding and the porous sound absorbing material 130b was not disposed. A gap of 2 mm is provided between the wall part and the partition member 34.

### Example 2

A ventilation-type silencer having the same structure as that of Example 1, except that the height of the partition member 34 was changed to 37 mm, the partition member 34 was integrally molded with the main body part, and the wall part and the partition member 34 adhered to each other with an adhesive not to have a gap therebetween, was produced.

### [Evaluation]

Transmission losses were measured for the produced ventilation-type silencers of Examples 1 and 2 and Comparative Examples 1 and 2.

The transmission loss was measured using an acoustic tube having a diameter of 24 mm, a speaker, and a microphone 4-terminal according to a transfer matrix measurement method (ASTM E2611). The measurement was performed with a self-made device, but can be reproduced with, for example, a commercially available 4-terminal method measurement set, such as WinZacMTX manufactured by Nihon Onkyo Engineering Co., Ltd. or 4206-T type transmission loss tube kit manufactured by B&K.

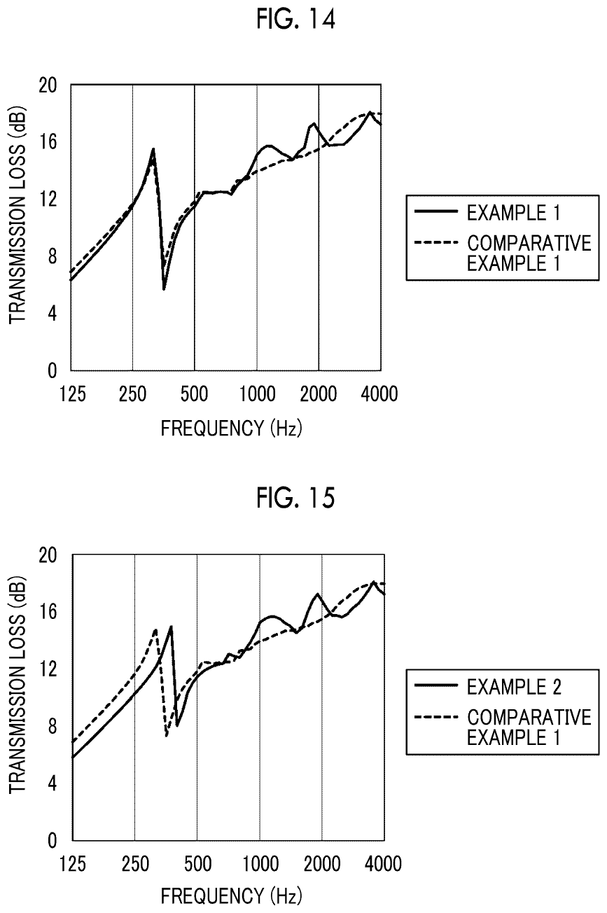

FIG. 13 shows graphs of measurement results of Comparative Example 1 and Comparative Example 2. FIG. 14 shows graphs of measurement results of Comparative Example 1 and Example 1. FIG. 15 shows graphs of measurement results of Comparative Example 1 and Example 2.

In each of Examples and Comparative Examples of the graphs shown in FIGS. 13 to 15, a large change in transmission loss near a frequency of 315 Hz depends on the natural vibration of the wall, which has a thickness of 2 mm, of the expansion section 14.

It can be seen from FIG. 13 that, in Comparative Example 1, a transmission loss is monotonically increased toward a high frequency side at a frequency except for near a frequency of 315 Hz. On the other hand, it can be seen that, in Comparative Example 2, sound deadening performance is significantly higher than that of Comparative Example 1 near a frequency of 1500 Hz but there is a band in which a transmission loss is less than that of Comparative Example 1 near frequencies of 1000 Hz, 2000 Hz, and the like. In particular, since a value of a transmission loss in Comparative Example 1 near a frequency of 1000 Hz was also smaller than that at a higher frequency in assumption, sound deadening performance was reduced near a frequency of 1000 Hz.

FIG. 14 shows a result in which a transmission loss near a frequency of 1000 Hz in Example 1 was significantly larger than that in Comparative Example 1. In Example 1, an acoustic resonator that has an air column resonator structure and has a width of 30 mm, a height of 37 mm, and a length of 50 mm is formed on the back side of the porous sound absorbing material by the partition member. The length of the acoustic resonator is 67 mm in consideration of opening end correction (calculated by obtaining an opening area and obtaining an equivalent circle radius), and a corresponding resonance frequency can be calculated as 1280 Hz. Since this is substantially the same as the maximum value of a transmission loss near a frequency of 1000 Hz in Example 1, it can be seen that a transmission loss near a frequency of 1000 Hz, which is lowered in Comparative Example 2, by the acoustic resonator formed on the back side of the porous sound absorbing material can be larger than that in Comparative Example 1 in which the porous sound absorbing material is filled. Further, it can be seen that high transmission loss can be maintained over a high frequency in a case where a remaining space is left large by the partition member.

It can be seen from FIG. 15 that characteristics at a frequency of 800 Hz or more in Example 2 substantially coincide with those in Example 1. On the other hand, Example 2 and Comparative Example 1 were different from each other in term of characteristics at a frequency of particularly 500 Hz or less. Since the partition member and the wall of the expansion section adhered to each other with no gap therebetween, a vibration frequency at a low frequency based on the resonance of the wall was increased to a high frequency and a transmission loss was smaller than that in Comparative Example 1 and Example 1 at a frequency lower than the low frequency. On the other hand, both end portions of the partition member in the height direction adhered to the wall of the expansion section, so that an H-shaped structure was formed and a structural strength was increased.

### Comparative Example 3

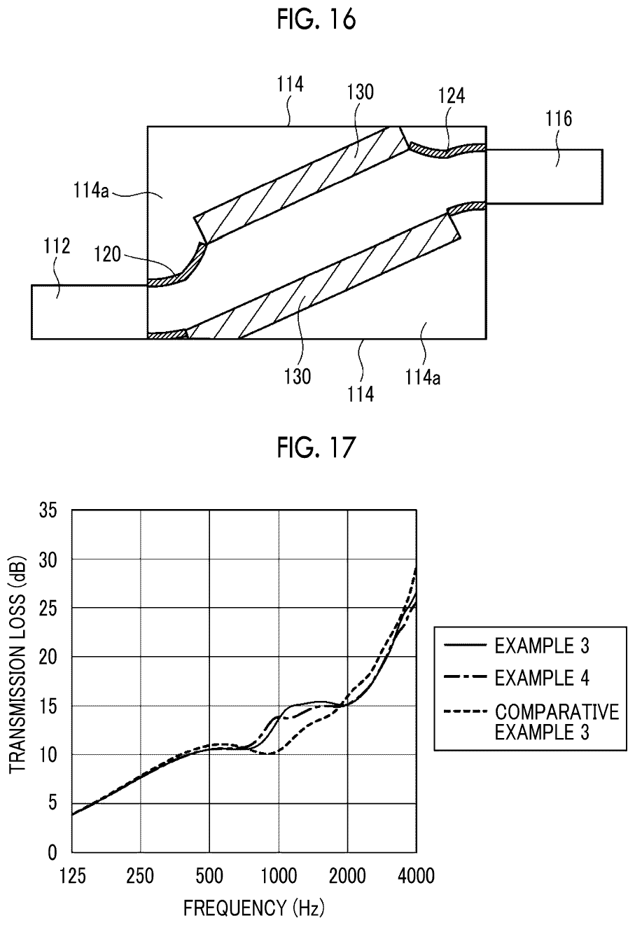

As shown in FIG. 16, a ventilation-type silencer having a structure in which the central axis of the inlet-side vent pipe 112 and the central axis of the outlet-side vent pipe 116 were not positioned on the same straight line, the porous sound absorbing materials 130 were disposed in a region along the flow channel in the expansion section 114, and back spaces 114a were formed was produced. The ventilation-type silencer shown in FIG. 16 has the same configuration as the ventilation-type silencer according to the embodiment of the present invention shown in FIG. 8, except that the partition member 34 is not provided.

An inner size of the expansion section 114 was set to a size of 110 mm in width (a vertical direction in FIG. 16)×47 mm in height (a direction perpendicular to the plane of paper)×170 mm in length (a horizontal direction in FIG. 16). Further, the vent pipes to be connected (the inlet-side vent pipe 112 and the outlet-side vent pipe 116) were formed in a rectangular shape with a size of 24 mm×24 mm. A first opening structure 120 was disposed at a connection portion of the expansion section 14 connected to the inlet-side vent pipe 112, and a second opening structure 124 was disposed at a connection portion thereof connected to the outlet-side vent pipe 116. Each of the first opening structure 120 and the second opening structure 124 was formed of two plate-like members curved such that a flow channel direction is bent by an angle of 20°, and was a structure in which the plate-like members were curved such that a cross-sectional area of the flow channel changes on a distal end side. Furthermore, a height of each of the first opening structure 120 and the second opening structure 124 in the direction perpendicular to the plane of paper was set to 24 mm, and the first opening structure 120 and the second opening structure 124 were disposed in contact with one of the walls of the expansion section 114 in the direction perpendicular to the plane of paper.

One wall of the expansion section 114 in a height direction was divided into two parts, that is, a wall part and a main body part as separate parts (fragments), and each of the parts was produced by injection molding. Further, the two opening structures were integrally molded with the main body part. Each of the two vent pipes was also produced by injection molding. An ABS resin was used as a material of each member. The thickness of the wall part was set to 2 mm, and the thickness of the other member was set to 5 mm. Rectangular through-holes having a size of 24 mm×24 mm to be connected to the vent pipes were formed in two walls of the main body part of the expansion section 114 in the length direction, respectively. The vent pipes adhered to the positions of the through-holes of the main body part of the expansion section 114.

As shown in FIG. 16, porous sound absorbing materials 130 (QonPET manufactured by Bridgestone KBG Co., Ltd.) were disposed in the main body part of the expansion section 114 along a region (a region in which distal ends of the two opening structures are connected to each other) serves as a flow channel such that back spaces were formed. The width of the porous sound absorbing material 130 in a direction orthogonal to the flow channel direction was set to 15 mm. Further, a porous sound absorbing material 130 having a thickness of 23 mm was disposed above the opening structure (in a direction perpendicular to the plane of paper) and above the porous sound absorbing materials 130 in the main body part. QonPET had a structure in which a nonwoven fabric layer having a high density and a small thickness and a nonwoven fabric layer having a low density and a large thickness were joined to each other, and the nonwoven fabric layer having a high density was disposed to face a flow channel side.

The porous sound absorbing materials were disposed in the expansion section 114 and the wall part then adhered to an opening surface of the main body part, so that the ventilation-type silencer was produced. An adhesive CA-243 for ABS manufactured by CEMEDINE CO., LTD. was used as an adhesive.

### Example 3

A ventilation-type silencer (see FIG. 8) having the same structure as that of Comparative Example 3, except that the partition member 34 was disposed in one back space, was produced.

The partition member 34 was a flat plate-like member having a thickness of 2 mm and a height of 45 mm, and was disposed at a position away from the wall in a width direction (a vertical direction in FIG. 8) of the main body part of the expansion section 14 by a distance of 20 mm such that one end portion thereof was in contact with one wall (a left wall in FIG. 8) of the expansion section 14 in a length direction and the other end portion thereof was in contact with the porous sound absorbing material 30. The partition member 34 was integrally molded with the main body part. A gap of 2 mm is provided between the wall part and the partition member 34.

### Example 4

A ventilation-type silencer (see FIG. 10) was produced in the same manner as in Example 3 except that a partition member 34 included a part (a plate-like member 34b) protruding toward an acoustic resonator 36b at an end portion thereof facing a porous sound absorbing material 30 and a Helmholtz resonator was used as the acoustic resonator 36b. A width of an opening portion of the acoustic resonator 36b (a distance between the plate-like member 34b and an upper wall of the expansion section 14 in FIG. 10) was set to 10 mm.

### Example 5

A ventilation-type silencer (see FIG. 9) having the same structure as that of Example 3, except that a partition member 34 was disposed in each of the two back spaces 14a, was produced.

### [Evaluation]

Transmission losses were measured for the produced ventilation-type silencers of Examples 3 to 5 and Comparative Example 3 by the same method as described above.

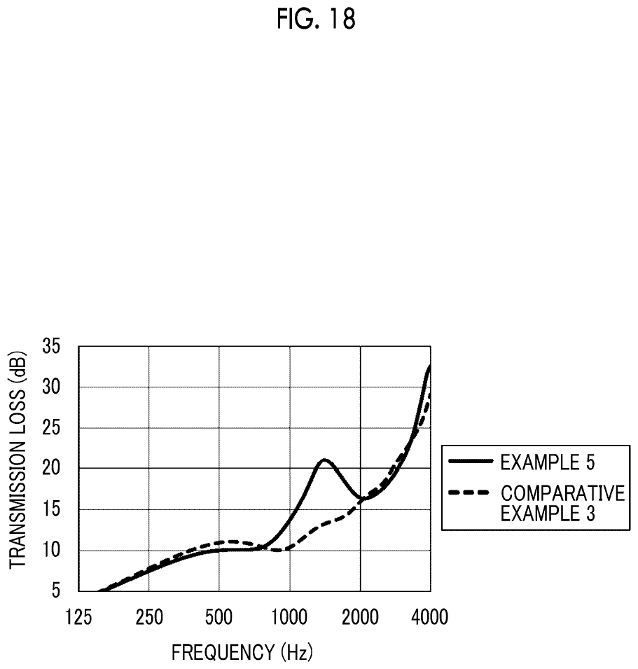

FIG. 17 shows graphs of measurement results of Comparative Example 3 and Examples 3 and 4. FIG. 18 shows graphs of measurement results of Comparative Example 3 and Example 5.

It can be seen from FIG. 17 that a transmission loss has the minimum value near a frequency of 1000 Hz in Comparative Example 3. On the other hand, it can be seen that a transmission loss at a frequency of 700 Hz to 2000 Hz can be increased and the amount of deadened sound can be increased since the acoustic resonator is provided on the back side of the porous sound absorbing material in Examples 3 and 4. Further, it can be seen that a peak is shifted to a lower frequency side in Example 4 than in Example 3. This means that a transmission loss on a lower frequency side can be increased even in an acoustic resonator having the same volume as that of Example 3 due to an effect of a slit Helmholtz resonator in a case where an inlet is narrowed.

It can be seen from FIG. 18 that an effect of increasing a transmission loss with the acoustic resonator is increased in Example 5 and the maximum value near a frequency of 1000 Hz is 16 dB in Example 3, whereas the maximum value is significantly improved to 21 dB in the structure of Example 4.

The effects of the present invention are clear from the results described above.

### EXPLANATION OF REFERENCES

10, 100: ventilation-type silencer
12, 112: inlet-side vent pipe
14, 114: expansion section
14a, 114a: back space
16, 116: outlet-side vent pipe
20, 20b to 20e, 120: first opening structure
24, 24d, 24c, 124: second opening structure
30, 130, 130b: porous sound absorbing material
34: partition member
34a, 34b: plate-like member
35: gap
36: acoustic resonator

What is claimed is:

1. A ventilation-type silencer including an inlet-side vent pipe, an expansion section that communicates with the inlet-side vent pipe and has a cross-sectional area larger than a cross-sectional area of the inlet-side vent pipe, and an outlet-side vent pipe that communicates with the expansion section and has a cross-sectional area smaller than the cross-sectional area of the expansion section, the ventilation-type silencer comprising:
a porous sound absorbing material that is disposed in at least a part of the expansion section;
a back space that is a space in the expansion section formed on a side of the porous sound absorbing material opposite to a flow channel connecting the inlet-side vent pipe and the outlet-side vent pipe; and
a partition member that partitions the back space,
wherein a region partitioned by the partition member forms an acoustic resonator,
the acoustic resonator is acoustically connected to the flow channel,
the partition member does not adhere to at least one of two walls surrounding the acoustic resonator and facing each other among walls of the expansion section,
a distance between the partition member and the at least one of two walls that does not adhere to the partition member is 1 mm or more and 5 mm or less,
each of the partition member and the at least one of two walls that does not adhere to the partition member is a flat surface, and
a lowest natural frequency of the at least one of two walls that does not adhere to the partition member after the ventilation-type silencer is formed to include the partition member is 2000 Hz or less.

2. The ventilation-type silencer according to claim 1,
wherein resonance of the acoustic resonator is air column resonance.

3. The ventilation-type silencer according to claim 1,
wherein the partition member includes a part that protrudes toward the acoustic resonator at an end portion thereof facing the porous sound absorbing material, and
resonance of the acoustic resonator is Helmholtz resonance.

4. The ventilation-type silencer according to claim 1,
wherein the partition member is in contact with the porous sound absorbing material.

5. The ventilation-type silencer according to claim 1,
wherein the partition member is formed integrally with the expansion section.

6. The ventilation-type silencer according to claim 5,
wherein a thickness of the partition member is constant or monotonically reduced in at least one direction of directions away from a wall of the expansion section from a position at which the partition member is joined to the wall of the expansion section.

7. The ventilation-type silencer according to claim 1,
wherein all sides of the partition member are straight.

8. The ventilation-type silencer according to claim 1, further comprising:
an opening structure that is provided on at least one of a connection portion of the expansion section connected to the inlet-side vent pipe or a connection portion of the expansion section connected to the outlet-side vent pipe and has a cross-sectional area gradually increased from the connection portion toward an inside of the expansion section.

9. The ventilation-type silencer according to claim 2,
wherein the partition member is in contact with the porous sound absorbing material.

10. The ventilation-type silencer according to claim 2,
wherein the partition member is formed integrally with the expansion section.

11. The ventilation-type silencer according to claim 10,
wherein a thickness of the partition member is constant or monotonically reduced in at least one direction of directions away from a wall of the expansion section from a position at which the partition member is joined to the wall of the expansion section.

12. The ventilation-type silencer according to claim 2,
wherein all sides of the partition member are straight.

13. The ventilation-type silencer according to claim 2, further comprising:
an opening structure that is provided on at least one of a connection portion of the expansion section connected to the inlet-side vent pipe or a connection portion of the expansion section connected to the outlet-side vent pipe and has a cross-sectional area gradually increased from the connection portion toward an inside of the expansion section.

14. The ventilation-type silencer according to claim 3,
wherein the partition member is in contact with the porous sound absorbing material.

15. The ventilation-type silencer according to claim 3,
wherein the partition member is formed integrally with the expansion section.

16. The ventilation-type silencer according to claim 15,
wherein a thickness of the partition member is constant or monotonically reduced in at least one direction of directions away from a wall of the expansion section from a position at which the partition member is joined to the wall of the expansion section.

17. The ventilation-type silencer according to claim 3,
wherein all sides of the partition member are straight.

18. The ventilation-type silencer according to claim 3, further comprising:
an opening structure that is provided on at least one of a connection portion of the expansion section connected to the inlet-side vent pipe or a connection portion of the expansion section connected to the outlet-side vent pipe and has a cross-sectional area gradually increased from the connection portion toward an inside of the expansion section.

19. The ventilation-type silencer according to claim 4,
wherein all sides of the partition member are straight.

20. The ventilation-type silencer according to claim 4, further comprising:
an opening structure that is provided on at least one of a connection portion of the expansion section connected to the inlet-side vent pipe or a connection portion of the expansion section connected to the outlet-side vent pipe and has a cross-sectional area gradually increased from the connection portion toward an inside of the expansion section.
